(19) United States
(12) Patent Application Publication
(10) Pub. No.: US 2014/0167714 A1
(43) Pub. Date: Jun. 19, 2014

(54) SOFT-START CIRCUITS AND POWER SUPPLIERS USING THE SAME

(71) Applicant: VIA TECHNOLOGIES, INC., New Taipei City (TW)

(72) Inventor: Yu-Chung WEI, New Taipei City (TW)

(73) Assignee: VIA TECHNOLOGIES, INC., New Taipei City (TW)

(21) Appl. No.: 14/091,579

(22) Filed: Nov. 27, 2013

Related U.S. Application Data
(60) Provisional application No. 61/737,364, filed on Dec. 14, 2012.

(30) Foreign Application Priority Data
Sep. 3, 2013 (TW) 102131623

(51) Int. Cl. H02M 1/36; H02M 3/156

(52) U.S. Cl. CPC H02M 1/36; H02M 3/156
USPC 323/266; 323/311

(57) ABSTRACT

A soft-start circuit is provided. The soft-start circuit generates an output voltage at an output terminal. The soft-start includes a transistor, a capacitor, and a current source. The transistor has a first terminal receiving an input voltage, a second terminal coupled to the output terminal, and a control terminal. The capacitor is coupled between the second terminal and the control terminal of the transistor. The current source is coupled between the control terminal of the transistor and a ground terminal. The capacitor and the current source modulate the output voltage by modulating a driving voltage at the control terminal to perform a soft-start operation of the output voltage.

### CROSS REFERENCE TO RELATED APPLICATIONS

This application claims the benefit of U.S. Provisional Application No. 61/737,364, filed on Dec. 14, 2012, the contents of which are incorporated herein by reference.

This application claims priority of Taiwan Patent Application No. 102131623, filed on Sep. 3, 2013, the entirety of which is incorporated by reference herein.

### BACKGROUND OF THE INVENTION

1. Field of the Invention

The invention relates to a soft-start circuit which performs a soft-start operation to an output voltage through a feedback control related to the output voltage.

2. Description of the Related Art

In current electronic circuits, some electronic circuits require reference voltages provided from external devices for operation. For example, DC-DC converters and low drop regulators (LDOs) require reference voltages and generate fixed output voltages according to the reference voltages. Based on the operation of these electronic circuits, the received reference voltages have to rise slowly from 0V to target voltages. The process of the received reference voltages rising slowly from 0V to target voltages is called a soft-start. Soft-start circuits have been provided to generate reference voltages which rise slowly from 0V to target voltages. However, in the known soft-start circuits, the rising time or rising slope of the reference voltages may be different with the different equivalent capacitances or resistances of the loads. This may cause that the known soft-start circuits are unable to generate reference voltages with stability. Moreover, the known soft-start circuits occupy large circuitry areas.

### BRIEF SUMMARY OF THE INVENTION

An exemplary embodiment of a soft-start circuit is provided. The soft-start circuit generates an output voltage at an output terminal. The rising time of the output voltage will not be effected by different equivalent capacitances or resistances of load. The soft-start comprises a transistor, a capacitor, and a current source. The transistor has a first terminal receiving an input voltage, a second terminal coupled to the output terminal, and a control terminal. The capacitor is coupled between the second terminal and the control terminal of the transistor. The current source is coupled between the control terminal of the transistor and a ground terminal. The capacitor and the current source modulate the output voltage by modulating a driving voltage at the control terminal to perform a soft-start operation of the output voltage.

An exemplary embodiment of a power supplier is provided. The power supplier generates a supplying voltage and comprises a voltage generation circuit and a soft-start circuit. The voltage generation circuit receives an output voltage and generates the supplying voltage according to the output voltage. The soft-start circuit generates the output voltage at an output terminal. The soft-start circuit comprises a transistor, a capacitor, and a current source. The transistor has a first terminal receiving an input voltage, a second terminal coupled to the output terminal, and a control terminal. The capacitor is coupled between the second terminal and the control terminal of the transistor. The current source is coupled between the control terminal of the transistor and a ground terminal. The capacitor and the current source modulate the output voltage by modulating a driving voltage at the control terminal to perform a soft-start operation of the output voltage.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an a soft-start circuit according to an exemplary embodiment of the present invention;

FIG. 2 shows a soft-start circuit according to another exemplary embodiment of the present invention;

FIG. 3 shows voltage level variation of a driving voltage and an output voltage of a soft-start circuit of the present invention;

FIG. 4 shows voltage level variation of a driving voltage and an output voltage when a PMOS transistor of a soft-start circuit is implemented as a power switch in different equivalent capacitances of a following circuit according to an exemplary embodiment;

FIG. 5 shows voltage level variation of a driving voltage and an output voltage when a PMOS transistor of a soft-start circuit is implemented as a power switch in different equivalent resistances of a following circuit according to an exemplary embodiment;

FIG. 6 shows a power supplier according to an exemplary embodiment of the present invention;

FIG. 7 shows a power supplier according to another exemplary embodiment of the present invention;

FIG. 8 shows voltage level variation of a driving voltage and an output voltage when a PMOS transistor has a small size according to an exemplary embodiment;

FIG. 9 shows a soft-start circuit according to further another exemplary embodiment of the present invention;

FIG. 10 shows voltage level variation of a driving voltage and an output voltage of the soft-start circuit of FIG. 9; and

FIG. 11 shows a soft-start circuit according to another exemplary embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

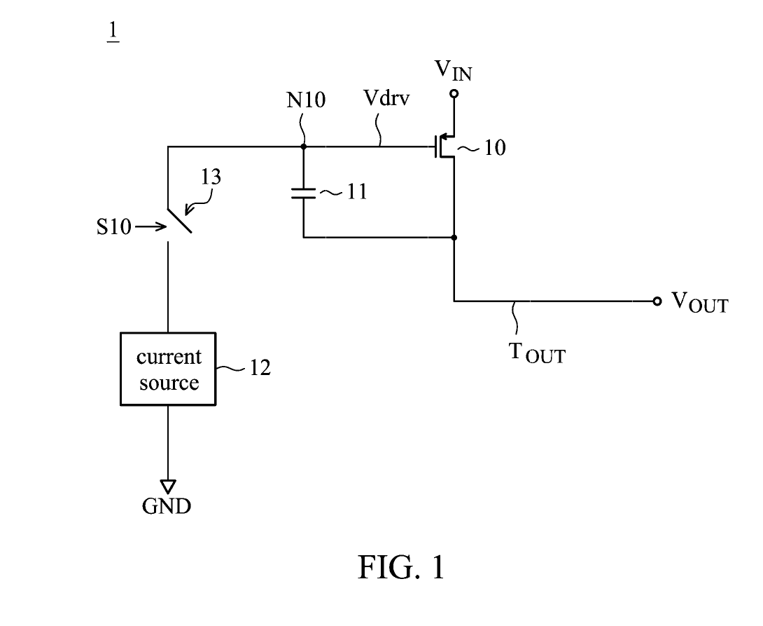

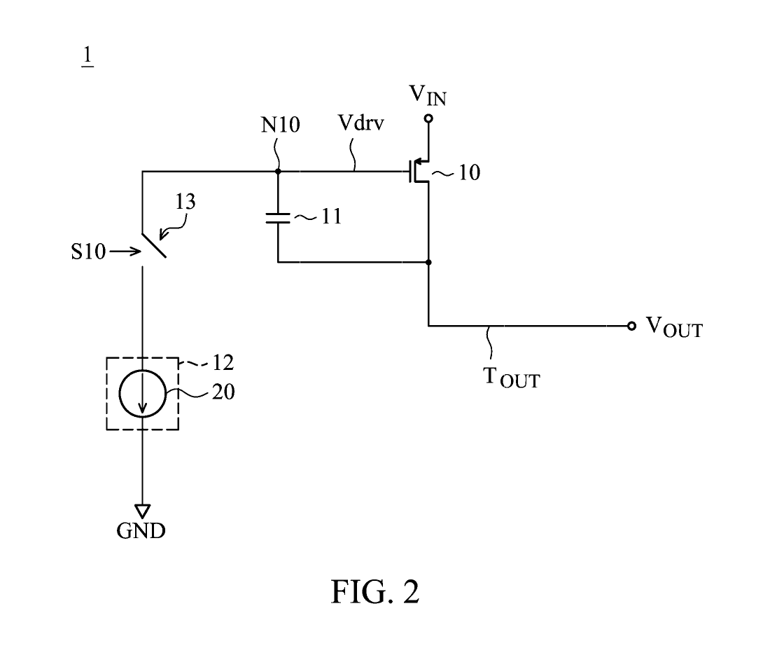

FIG. 1 shows a soft-start circuit according to one exemplary embodiment of the present invention. Referring to FIG. 1, the soft-start circuit 1 generates an output voltage V_{OUT} at an output terminal T_{OUT} of the soft-start circuit 1. The soft-start circuit 1 comprises a transistor 10, a capacitor 11, a current source 12, and a switch 13. In the embodiment of FIG. 1, the transistor 10 is implemented by a P-type metal-oxide semiconductor (PMOS) transistor. The source (first terminal) of the PMOS transistor 10 is coupled to an input voltage V_{IN}, the drain (second terminal) thereof is coupled to the output terminal T_{OUT}, and the gate (control terminal) thereof is coupled to a node N10. The capacitor 11 is coupled between the gate (that is, the node N10) and the drain (that is, the output terminal T_{OUT}) of the PMOS transistor 10. The switch 13 is coupled between the gate of the PMOS transistor 10 and the current source 12. The current source 12 is coupled between the switch 13 and a ground terminal GND. A control signal S10 is received by the switch 13 and the switch 13 is selectively turned on or turned off according to the control signal S10. As shown in FIG. 1, when the switch 13 is turned on, the current source 12 is coupled to the node N10. FIG. 2 shows a soft-start circuit according to one exemplary embodiment of the present invention. Compared with the soft-start circuit of FIG. 1, the difference between FIGS. 1 and 2 is that the current source 12 in FIG. 2 is implemented by a constant current source 20. The constant current source 20 is coupled between the switch 13 and the ground terminal GND. The remaining circuits in FIG. 2 are the same as FIG. 1, and the related description is omitted.

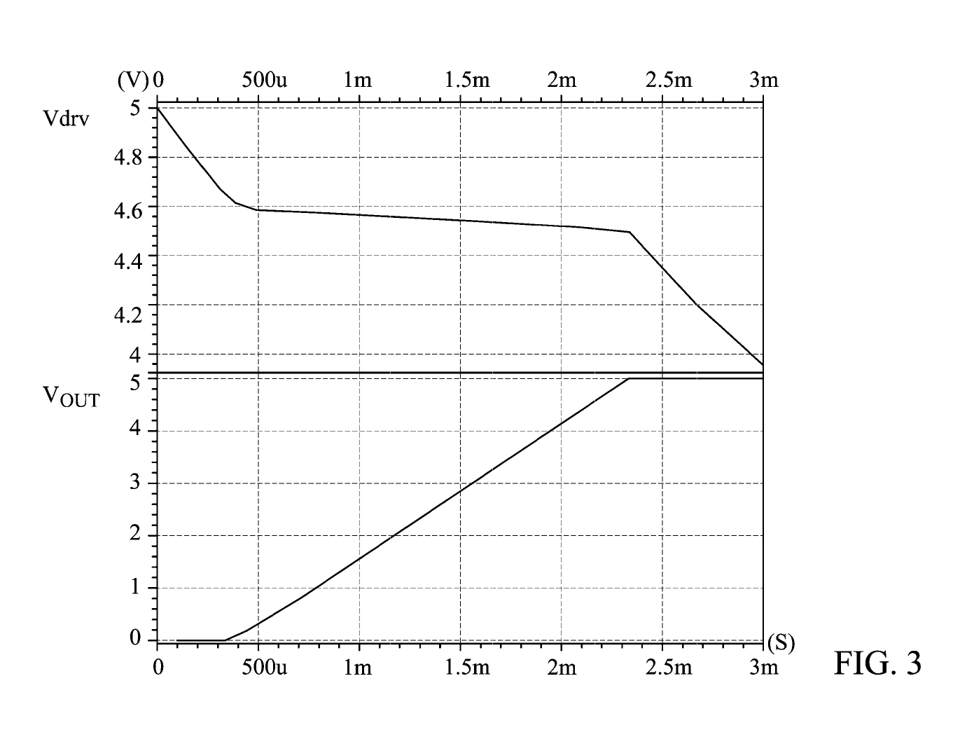

Referring to FIG. 2, before the soft-start circuit 1 performs a soft-start operation, a voltage level of a driving voltage Vdrv at the node N10 (that is the gate voltage of the PMS transistor 10) is initially set to be equal to a voltage level of the input voltage V_{IN} to turn off or disable the PMOS transistor 10. At this time, the switch 13 is in a turned-off state according to the control signal S10. In an embodiment, when a voltage level of the gate voltage of the PMOS transistor 10 is set to be equal to the voltage level of the input voltage V_{IN}, a voltage level of the output voltage V_{OUT} is set to be equal to 0V (the voltage level of the ground terminal GND). When the soft-start circuit 1 is required to perform the soft-start operation, the switch 13 is switched to a turned-on state from the turned-off state according to the control signal S10. The current of the current source 12 starts to discharge when the switch 13 couples the current source 12 to the node N10. In other words, when the switch 13 is switched to the turned-on state from the turned-off state, the voltage level of the driving voltage Vdrv at the node N10 starts falling from the level which is initially set (that is the voltage level of the input voltage V_{IN}). The falling speed of the driving voltage Vdrv is directly proportional to the current value of the current source 12. As shown in the embodiment of FIG. 2, the current source 12 is a constant current source. Thus, the voltage level of the driving voltage Vdrv falls linearly from the voltage level which is initially set (that is the level of the input voltage V_{N}) as shown by a waveform of the driving voltage Vdrv in an time interval from 0 us to 300 us in FIG. 3. In an embodiment, the voltage level of the driving voltage Vdrv falls from the voltage level which is initially set (that is the level of the input voltage V_{N}) by a first slope in this time interval.

Due to the falling of the voltage level of the driving voltage Vdrv, the voltage difference between the gate and the source of the PMOS transistor 10 (referred to as gate-source voltage difference) increases gradually. When the gate-source voltage difference increases gradually to a specified value (note that the specified value is less than the threshold of the PMOS transistor 10), the transistor 10 operates in a sub-threshold region and generates a sub-threshold current flowing through the PMOS transistor 10. At this time, the output terminal T_{OUT} and the capacitor 11 are charged by the sub-threshold current, such that the voltage level of the output voltage V_{OUT} starts rising. Through a coupling effect of the capacitor 11, the output voltage V_{OUT} with the rising voltage level is coupled to the node N10 (that is the gate of the PMOS transistor 10), such that the voltage level of the driving voltage Vdrv has a rising tendency. However, the voltage level of the driving voltage Vdrv has a falling tendency due to the discharging of the constant current source 20. Thus, when the transistor 10 operates the sub-threshold region, the falling speed of the voltage level of the driving voltage Vdrv is slower than the falling speed in the time interval from 0 us to 300 us, as shown by the waveform of the driving voltage Vdrv in an time interval from 300 us to 350 us in FIG. 3.

When the transistor 10 operates in the sub-threshold region, the gate-source voltage difference increases gradually. The transistor 10 is switched to operation in the saturation region to generate a saturation current flowing through the transistor 10 when the gate-source voltage difference increases to a voltage level that is larger than the threshold voltage of the transistor 10. The transistor 10 then charges the output terminal T_{OUT} and the capacitor 11 by the saturation current, such that the voltage level of the output voltage V_{OUT} rises. Similarly to the above sub-threshold region, the voltage level of the driving voltage Vdrv has a rising tendency by coupling the output voltage V_{OUT} with the rising voltage level to the node N10 through the capacitor 11. In detail, when the transistor 10 operates in the saturation region, the voltage level of the driving voltage Vdrv is affected by two factors: (1) the falling tendency induced by the discharging of the constant current source 20; and (2) the rising tendency induced by the rising of the voltage level of the output voltage V_{OUT}. Moreover, when the transistor 10 operates in the saturation region, the transistor 10 is equivalent to a constant current source to output a fixed saturation current. Thus, the voltage level of the driving voltage Vdrv is affected by the constant current source 20 and the fixed saturation current, such that the voltage level of the driving voltage Vdrv falls slowly and linearly and remains approximately in a fixed voltage level range, as shown by a waveform of the driving voltage Vdrv I an time interval from 350 us to 2.3 ms in FIG. 3. In an embodiment, the voltage level of the driving voltage Vdrv falls by a second slope in this time interval. In other words, when the transistor 10 is not turned on and does not operate in the sub-threshold region, the voltage level of the driving voltage Vdrv is affected only by the discharging of the current source 12 to fall linearly (as described above, falling by the first slope). When the transistor 10 operates in the saturation region, the driving voltage Vdrv is affected by the rising of the voltage level of the output voltage V_{OUT}, and the falling tendency of the voltage level of the driving voltage Vdrv is slowed down. The voltage level of the driving voltage Vdrv does not fall by the first slope any more. The voltage level of the driving voltage Vdrv is modulated to fall slowly and linearly and remains approximately in a fixed voltage level range (as described above, falling by the second slope). The situation that the voltage level of the driving voltage Vdrv remaining in the fixed voltage level range causes the transistor 10 to be remained in the saturation region, such that the voltage level of the output voltage V_{OUT} rises smoothly and linearly. As described above, when the transistor 10 is turned on, the voltage level of the driving voltage Vdrv falls by the first slope until the voltage level of the output voltage V_{OUT} starts rising. After entering the saturation region, the voltage level driving voltage Vdrv at the gate of the PMOS transistor 10 falls slowly (for example, by the second slope) and remains approximately in a fixed voltage level range. Accordingly, the voltage level of the output voltage V_{OUT} rises slowly and linearly from 0V toward the voltage level of the input voltage V_{IN}, continuously. Referring to FIG. 3, when the voltage level of the output voltage V_{OUT} rises and approaches the voltage level of the input voltage V_{IN}, the voltage level of the output voltage V_{OUT} does not rise any more. At this time, the rising tendency (that is the rising tendency induced by the rising of the voltage level of the output voltage V_{OUT}) to the voltage level of the driving voltage Vdrv is eliminated. Once the rising tendency is eliminated, the voltage level of the driving voltage Vdrv falls by a third slope and finally falls to 0V.

According to the above description, the voltage level of the output voltage V_{OUT} is initially set as 0V. When the voltage level of the driving voltage Vdrv falls slowly and linearly and remains approximately in a fixed voltage level range, the voltage level of the output voltage V_{OUT} rises linearly, smoothly, and gradually. Finally, the voltage level of the output voltage V_{OUT} approaches and remains at the voltage level of the input voltage V_{IN}. Accordingly, the soft-start operation for the output voltage V_{OUT} is achieved. Moreover, as described above, the soft-start operation is implemented by the physical behavior of the PMOS transistor 10, the capacitor 11, and the constant current source 20. Particularly, when the voltage level of the output voltage V_{OUT} rises gradually, the voltage level of the driving voltage Vdrv at the gate of the PMOS transistor 10 is modulated automatically through the capacitor 11 coupled between the gate and the drain of the PMOS transistor 10.

Referring to FIG. 3, during the process in which the voltage level of the output voltage V_{OUT} rises from 0V to the level of the input voltage V_{IN} (that is in the time interval from 350 us to 2.4 ms), the voltage level of the output voltage V_{OUT} rises linearly. Moreover, according to the embodiment of FIG. 2, the first slope is equal to the third slope. In cases where the voltage level of the driving voltage Vdrv starts falling slowly by the second slope according to the above falling tendency and the rising tendency, the second slope is less than the first slope and also less than the third slope.

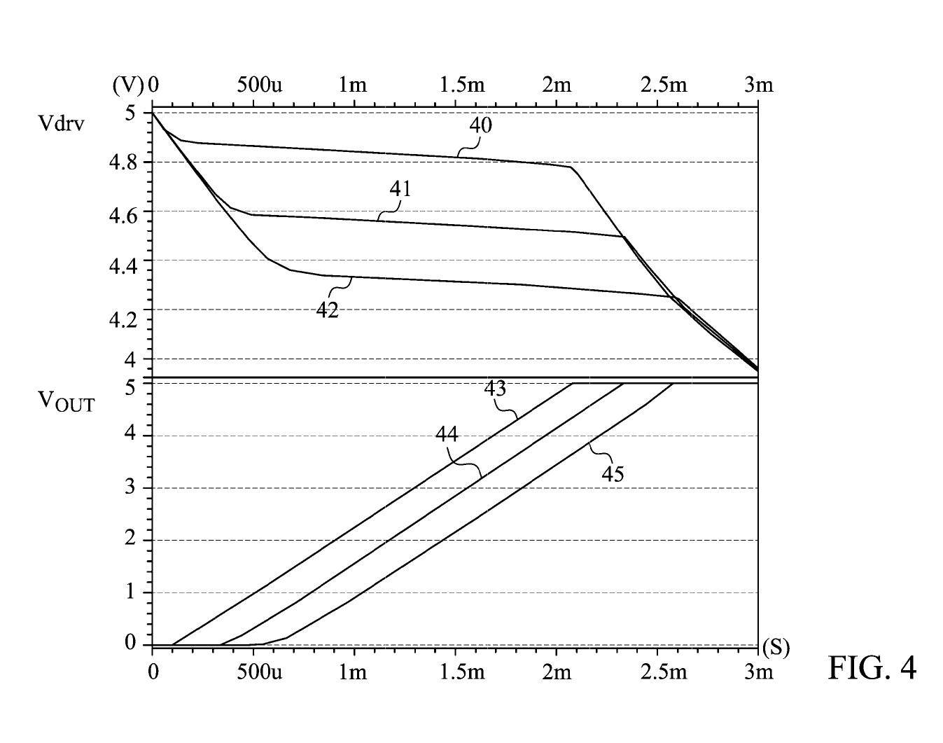

In some embodiments, the PMOS transistor 10 of the soft-start circuit 1 has a large size in order to serve as a power switch. In this case, the soft-start circuit 1 with the large-size PMOS transistor 10 can be implemented in a power stage in circuit system to provide the output voltage V_{OUT} to a following circuit. FIG. 4 shows the voltage level variation of the driving voltage Vdrv and the output voltage V_{OUT} when the PMOS transistor 10 is implemented as a power switch in different equivalent capacitances of the following circuit. Since the PMOS transistor 10 has a large size, the input voltage V_{IN} can be a voltage of 5V. In FIG. 4, the curve 40 presents the voltage level of the driving voltage Vdrv when there is no equivalent capacitance of the following circuit (that is the equivalent capacitance is equal to 0). The curves 41 and 42 present the voltage level of the driving voltage Vdrv when the equivalent capacitance of the following circuit is equal to 0.1 uF (micro Farad) and 10 uF, respectively. The curve 43 presents the voltage level of the output voltage V_{OUT} when there is no equivalent capacitance of the following circuit. The curve 44 presents the voltage level of the output voltage V_{OUT} when the equivalent capacitance of the following circuit is equal to 0.1 uF. The curve 45 presents the voltage level of the output voltage V_{OUT} when the equivalent capacitance of the following circuit is equal to 10 uF.

Referring to the curves 40 and 43 in FIG. 4, when there is no equivalent capacitance of the following circuit, the voltage level of the driving voltage Vdr falls to 4.9V from 5V (the initial level) in 100 us after the switch 13 is turned on. Then, in an time interval from 100 us to 2.1 ms (millisecond), the voltage level of the driving voltage Vdrv falls slowly and linearly and remains approximately in a fixed voltage level range. In the time interval from 100 us to 2.1 ms, the voltage level of the output voltage V_{OUT} rises from 0V to 5V linearly and smoothly. Thus, in cases when there is no equivalent capacitance of the following circuit, the time period of the soft-start operation to the output voltage V_{OUT} is 2 ms. Referring to the curves 41 and 44 in FIG. 4, when the equivalent capacitance of the following circuit is equal to 0.1 uF, in the interval from 300 us to 2.3 ms after the switch 13 is turned on, the voltage level of the output voltage V_{OUT} rises from 0V to 5V linearly and smoothly. Thus, in the case when the equivalent capacitance of the following circuit is equal to 0.1 uF, the time period of the soft-start operation to the output voltage V_{OUT} is also 2 ms. Also referring to the curves 42 and 45 in FIG. 4, when the equivalent capacitance of the following circuit is equal to 10 uF, in the time interval from 600 us to 2.6 ms after the switch 13 is turned on, the voltage level of the output voltage V_{OUT} rises from 0V to 5V linearly and smoothly. Thus, in cases when the equivalent capacitance of the following circuit is equal to 10 uF, the time period of the soft-start operation to the output voltage V_{OUT} is also 2 ms. According the above description, no matter the value of the equivalent capacitance of the following circuit, the time period when the voltage level of the output voltage V_{OUT} rises from 0V to 5V is 2 ms. Moreover, according to the curves 43-45, the slopes of the 0V-to-5V rising curves of the voltage level of the output voltage V_{OUT} are approximately equal to each other. Thus, the rising time and curve slope of the output voltage V_{OUT} applied by the soft-start operation are not affected by the equivalent capacitance of the following circuit.

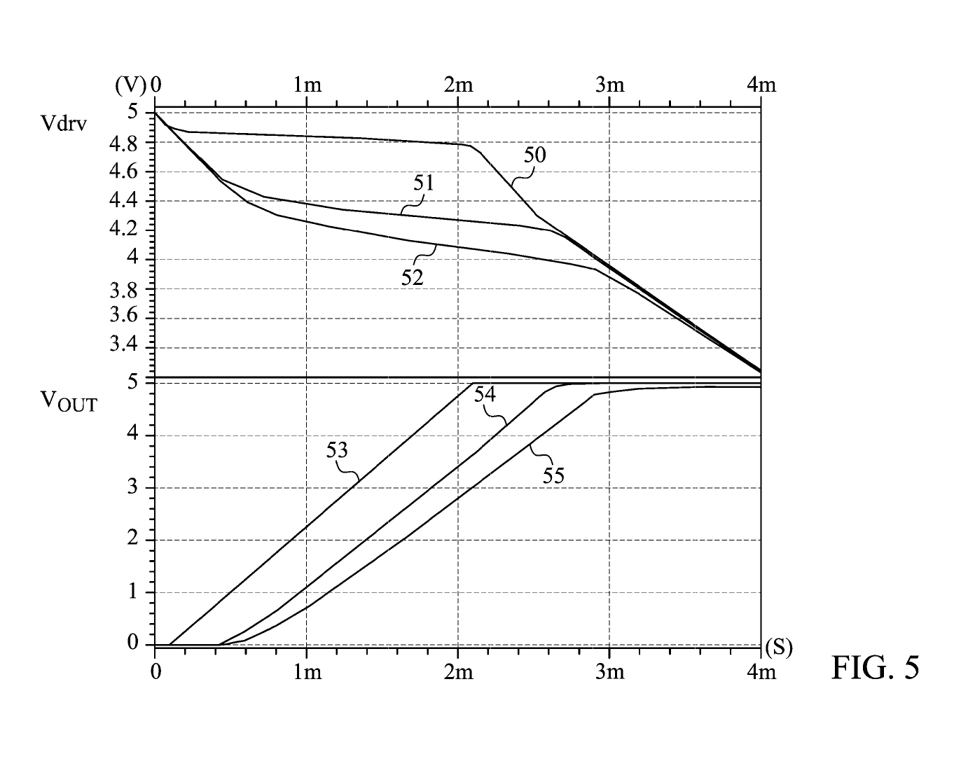

FIG. 5 shows the voltage level variation of the driving voltage Vdrv and the output voltage V_{OUT} when the PMOS transistor 10 is implemented as a power switch in different equivalent resistances of the following circuit. Since the PMOS transistor 10 has a large size, the voltage level input voltage V_{IN} can be 5V. In FIG. 5, the curve 50 presents the voltage level of the driving voltage Vdrv when there is no equivalent resistance of the following circuit (that is the equivalent resistance is equal to 0). The curves 51 and 52 present the voltage level of the driving voltage Vdrv when the equivalent resistance of the following circuit is equal to 100 ohm and 10 ohm, respectively. The curve 53 presents the voltage level of the output voltage V_{OUT} when there is no equivalent resistance of the following circuit. The curves 54 and 55 present the voltage level of the output voltage V_{OUT} Vdrv when the equivalent resistance of the following circuit is equal to 100 ohm and 10 ohm, respectively.

Referring to the curves 50 and 53 in FIG. 5, when there is no equivalent resistance of the following circuit, the voltage level of the driving voltage Vdr falls to 4.9V from 5V (initial voltage level) in 100 us after the switch 13 is turned on. Then, in the time interval from 100 us to 2.1 ms, the voltage level of the driving voltage Vdrv falls slowly and linearly and remains approximately in a fixed voltage level range. In the time interval from 100 us to 2.1 ms, the voltage level of the output voltage V_{OUT} rises from 0V to 5V linearly and smoothly. Thus, in cases when there is no equivalent resistance of the following circuit, the time period of the soft-start operation to the output voltage V_{OUT} is 2 ms. Referring to the curves 51 and 54 in FIG. 5, when the equivalent resistance of the following circuit is equal to 100 ohm, in the time interval from 400 us to 2.5 ms after the switch 13 is turned on, the voltage level of the output voltage V_{OUT} rises from 0V to 5V linearly and smoothly. Thus, in the case when the equivalent resistance of the following circuit is equal to 100 ohm, the time period of the soft-start operation to the output voltage V_{OUT} is also 2.1 ms. Also referring to the curves 52 and 55 in FIG. 5, when the equivalent resistance of the following circuit is equal to 10 ohm, in the time interval from 600 us to 2.8 ms after the switch 13 is turned on, the voltage level of the output voltage V_{OUT} rises from 0V to 5V linearly and smoothly. Thus, in the case when the equivalent resistance of the following circuit is equal to 10 ohm, the time period of the soft-start operation to the output voltage V_{OUT} is also 2.2 ms. According the above description, the time period of the voltage level of the output voltage V_{OUT} rising from 0V to 5V is not seriously affected by the equivalent resistance of the following circuit.

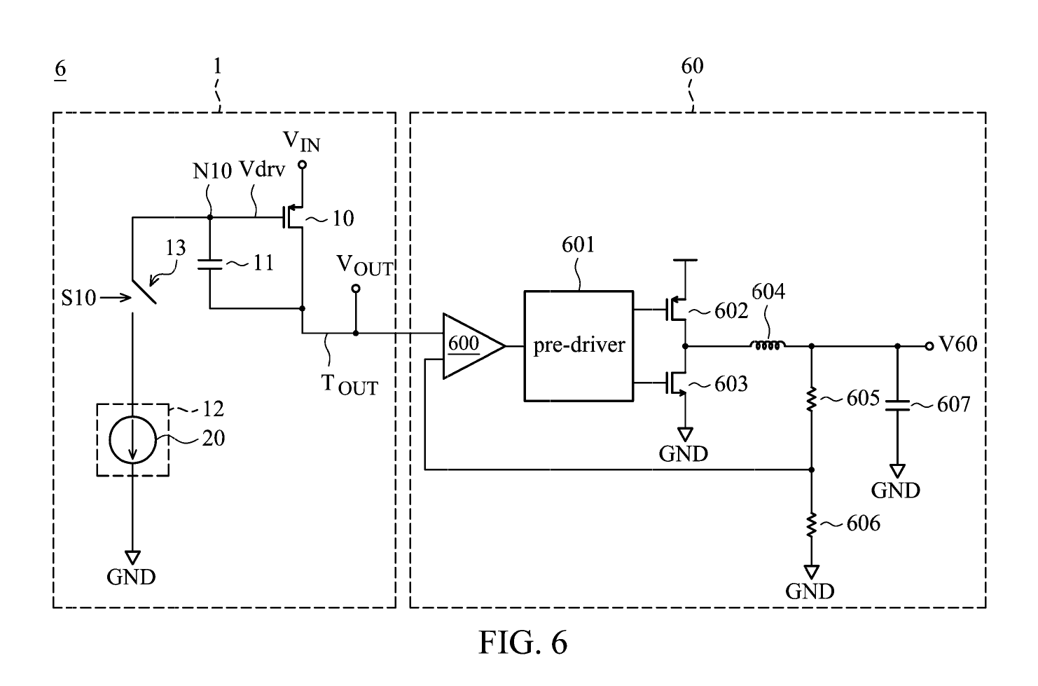

In some other embodiments, the soft-start circuit 1 can be applied to a power supplier for providing the output voltage V_{OUT} to serve as a reference voltage of the power supplier, such that the power supplier can generate a fixed supplying voltage according to the output voltage V_{OUT}. In these embodiments, the PMOS transistor 10 has a small size. Referring to FIG. 6, a power supplier 6 comprises the soft-start circuit 1 of FIG. 1 and a voltage generation circuit 60. In the embodiment, the voltage generation circuit 60 is implemented by a DC-DC converter. The voltage generation circuit 60 comprises an amplifier 600, a per-driver 601, a PMOS transistor 602, an N-type metal-oxide semiconductor (NMOS) transistor 603, an inductor 604, resistor 605 and 606, and a capacitor 607. The amplifier 600 receives the output voltage V_{OUT} from the soft-start circuit 1 to serve as a reference voltage. The resistors 605 and 606 divide a supplying voltage V60 for feeding back to the amplifier 600. The amplifier 600 generates a signal according to the divided supplying voltage V60 and the output voltage V_{OUT} serving as the reference voltage to control the switching operations of the PMOS transistor 602 and the NMOS transistor 603 through the pre-driver 601, thereby generating the fixed supplying voltage V60. In the embodiment of FIG. 6, the structure of the voltage generation circuit 60 serving as a DC-DC converter is an example without limitation. In other embodiments, the voltage generation circuit 60 may have another structure to achieve DC-DC conversion.

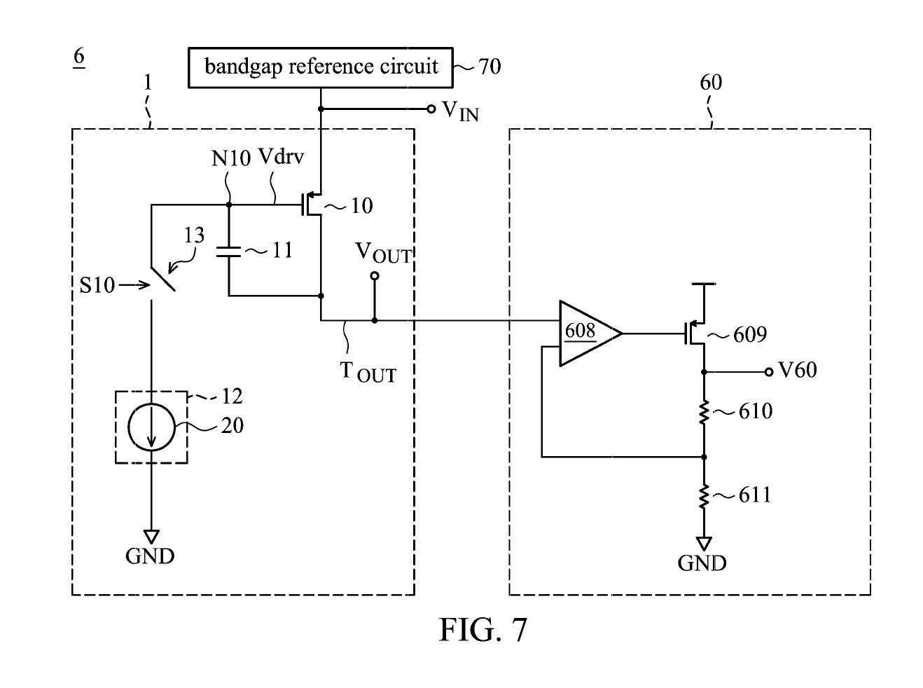

Moreover, in other some embodiments, the voltage generation circuit 60 is implemented by a low drop regulator (LDO). As shown in FIG. 7, the voltage generation circuit 60 comprises an amplifier 608, a PMOS transistor 609, and resistors 610 and 611. The amplifier 608 receives the output voltage V_{OUT} from the soft-start circuit 1 to serve as a reference voltage. The resistors 610 and 611 divide the supplying voltage V60 for feeding back to the amplifier 608. The amplifier 608 generates a signal according to the divided supplying voltage V60 and the output voltage V_{OUT} serving as the reference voltage to control the PMOS transistor 609, thereby generating the fixed supplying voltage V60. In the embodiment of FIG. 7, the power supplier 6 further comprises a bandgap reference circuit 70 which generates a bandgap voltage V70 to serve as the input voltage V_{IN} of the soft-start circuit 1. The bandgap voltage V70 generated by the bandgap reference circuit 70 will not be affected by the temperature and the process variation. Thus, the bandgap voltage V70 is a stable voltage. Moreover, the bandgap voltage V70 is more accurate. In the embodiment of FIG. 7, the structure of the voltage generation circuit 60 serving as a low drop regulator is an example without limitation. In other embodiments, the voltage generation circuit 60 may have another structure to achieve low-drop regulation. Moreover, in the embodiment of FIG. 7, the bandgap voltage V70 may have a known structure or any other structures which can generate a bandgap voltage not affected by the temperature and the process variation.

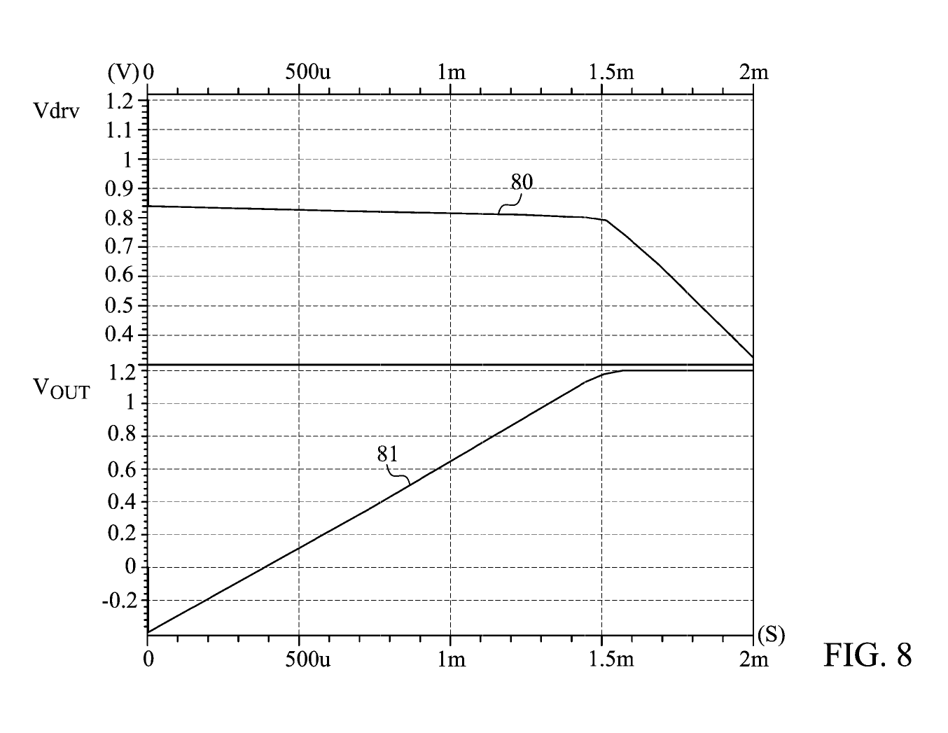

In the embodiments of FIGS. 6 and 7, the PMOS transistor 10 has a small size, and the components of the power supplier 6 are packeted in one chip. FIG. 8 shows the voltage level variation of the driving voltage Vdrv and the output voltage V_{OUT} when the PMOS transistor 10 has a small size. Since the PMOS transistor 10 has a small size, the components of the power supplier 6 are packeted in one chip. The voltage level of the input voltage V_{IN} of the power supplier 6 is usually less than 1.2V. Referring to FIG. 8, the curve 80 represents the voltage level of the driving voltage Vdrv when there is no equivalent capacitance of the following circuit (that is the equivalent capacitance is equal to 0) or when the equivalent capacitance of the following circuit is equal to 1 pf (pico Farad) or 10 pf. The curve 81 represents the voltage level of the output voltage V_{OUT} when there is no equivalent capacitance of the following circuit or when the equivalent capacitance of the following circuit is equal to 1 pf or 10 pf. In the embodiment, no matter the equivalent capacitance of the following circuit being equal to 0, 1 pf. or 10 pf, the curve of the corresponding voltage level of the driving voltage Vdrv is the same (that is the curve 80), and the curve of the corresponding voltage level of the output voltage V_{OUT} is also the same (that is the curve 81). Referring to FIG. 8, at the moment when the PMOS transistor 10 is turned on, the voltage level of the driving voltage Vdrv falls rapidly, for example from 1.2V to 0.84V). Since the rapid falling of the voltage level of the driving voltage Vdrv, the voltage level of the output voltage V_{OUT} also falls rapidly to −0.3V through the coupling effect of the capacitor 11. Then, the voltage level of the output voltage V_{OUT} rises from −0.3V to 1.2V in the time interval from 0 s to 1.6 ms after the switch 13 is turned on.

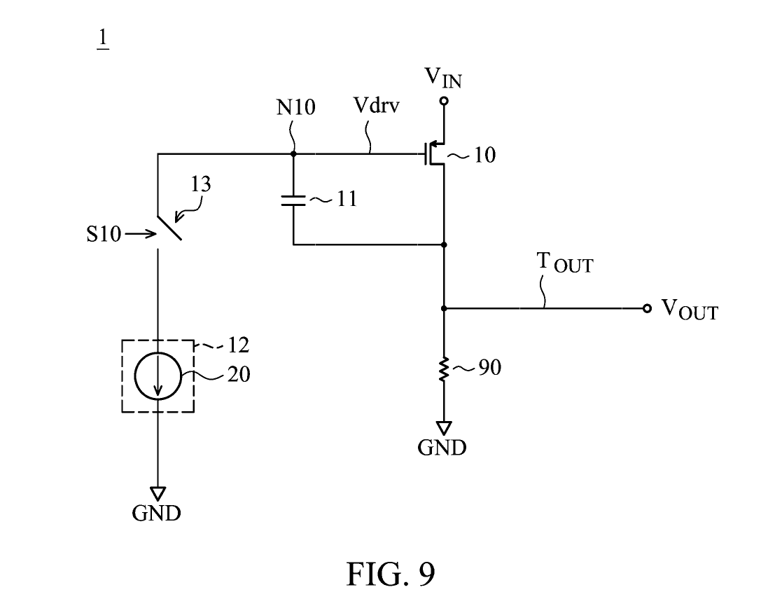

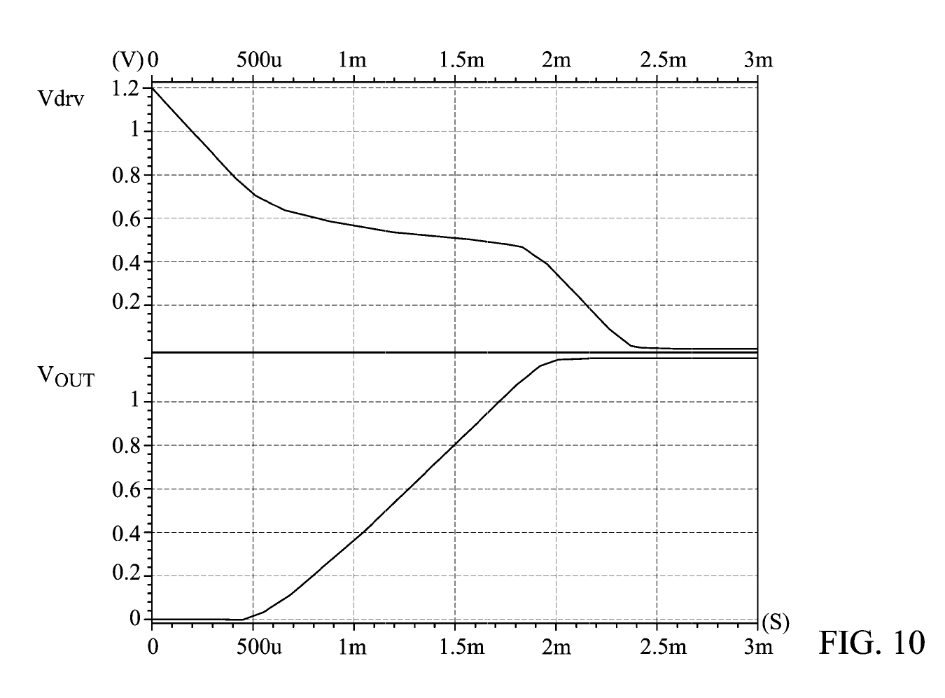

In some embodiments, when the PMOS transistor 10 is implemented with a transistor with a small size, the soft-start circuit 1 can further comprise a resistor to eliminate the above initial negative voltage level drop of the output voltage V_{OUT}. As shown in FIG. 9, the soft-start circuit 1 further comprises a resistor 90 coupled between the output terminal T_{OUT} and the ground terminal GND. FIG. 10 shows the voltage level variation of the driving voltage Vdrv and the output voltage V_{OUT} when the PMOS transistor 10 has a small size and there is a resistor 90 coupled to the output terminal T_{OUT}. In the embodiment, the resistance of the resistor 90 is 100 Kohm. Referring to FIGS. 9 and 10, at the moment when the PMOS transistor 10 is turned on, since the resistor 90 provides a voltage to the output terminal T_{OUT}, the voltage level of the output voltage V_{OUT} is 0V, or it falls slightly to −0.2V. Accordingly, at the moment when the PMOS transistor 10 is turned on, the above initial negative voltage level drop of the output voltage V_{OUT} can be eliminated by coupling the resistor 90 to the output terminal T_{OUT}.

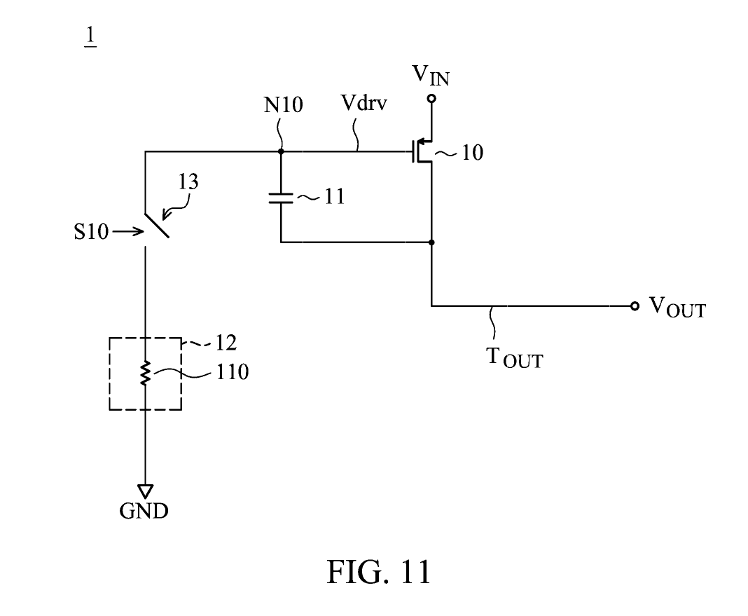

In the above embodiments, the current source 12 is implemented by a constant current source 20. In other embodiments, the current source can be implemented by a variable current source. Referring to FIG. 11, the current source 12 comprises a resistor 110 coupled between the second terminal of the switch 13 and the ground terminal GND. The PMOS transistor 10, the capacitor 11, the current source 12, the switch 13, and the resistor 110 are disposed in the same chip.

Referring to FIG. 11, before the soft-start circuit 1 performs the soft-start operation, the voltage level of the driving voltage Vdrv at the node N10 is initially set to be equal to the voltage level of the input voltage V_{IN}, and the voltage level of the output voltage V_{OUT} is set as 0V. When the soft-start circuit 1 is required to perform the soft-start operation, the switch 13 is switched to a turned-on state from the turned-off state according to the control signal S10. At this time, the voltage level of the driving voltage Vdrv at the node N10 starts falling from the level rapidly due to the discharging through the discharging path formed by the transistor 110. Due to the falling of the voltage level of the driving voltage Vdrv, the voltage difference between the gate and the source of the PMOS transistor 10 (referred to as gate-source voltage difference) increases gradually. When the gate-source voltage difference increases gradually to a specified value (note that the specified value is less than the threshold of the PMOS transistor 10), the transistor 10 operates in a sub-threshold region and generates a sub-threshold current flowing through the PMOS transistor 10. At this time, the output terminal T_{OUT} and the capacitor 11 are charged by the sub-threshold current, such that the voltage level of the output voltage V_{OUT} starts rising. Through the coupling effect of the capacitor 11, the output voltage V_{OUT} with the rising voltage level is coupled to the node N10 (that is the gate of the PMOS transistor 10), such that the voltage level of the driving voltage Vdrv has a rising tendency. However, the voltage level of the driving voltage Vdrv has a falling tendency due to the discharging through the resistor 110. When the transistor 10 operates in the sub-threshold region, the gate-source voltage difference increases gradually. The transistor 10 is switched to operate in the saturation region to generate a saturation current flowing through the transistor 10 when the gate-source voltage difference increases to be larger than the threshold voltage of the transistor 10. The transistor 10 then charges the output terminal T_{OUT} and the capacitor 11 by the saturation current, such that the voltage level of the output voltage V_{OUT} rises. When the transistor 10 operates in the saturation region, the transistor 10 is equivalent to a constant current source to output a fixed saturation current. Thus, the voltage level of the driving voltage Vdrv falls slowly and linearly and remains approximately in a fixed voltage level range. Since the voltage level of the driving voltage Vdrv falls slowly and linearly and remains approximately in the fixed voltage level range, the voltage level of the output voltage V_{OUT} continuously rises toward the voltage level of the input voltage V_{IN}. The voltage level of the driving voltage Vdrv remaining in the fixed voltage level range causes the transistor 10 to remain in the saturation region, such that the voltage level of the output voltage rises linearly and smoothly. When the voltage level of the output voltage V_{OUT} rises and approaches the voltage level of the input voltage V_{IN}, the voltage level of the output voltage V_{OUT} does not rise any more, such that the rising tendency to the voltage level of the driving voltage Vdrv through the coupling effect of the capacitor 11 is eliminated. Once the rising tendency is eliminated, the voltage level of the driving voltage Vdrv falls rapidly and finally reaches to 0V.

According to the above description, the soft-start circuit 1 of the present invention can control the voltage level of the driving voltage Vdrv through the feedback control of the capacitor 11, such that the soft-start operation can be achieved to the output voltage V_{OUT}. The circuit components used to achieve the soft-start operation (including PMOS transistor 10, the capacitor 11, the current source 12 and so on) and the power supplier can be packaged/disposed in the same chip, thereby decreasing the circuit area. Moreover, the rising time of the voltage level of the output voltage V_{OUT} is almost not affected by different equivalent capacitances or different equivalent resistances of the loads.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A soft-start circuit for generating an output voltage at an output terminal, comprising:
a transistor having a first terminal receiving an input voltage, a second terminal coupled to the output terminal, and a control terminal;
a capacitor coupled between the second terminal and the control terminal of the transistor; and
a current source coupled between the control terminal of the transistor and a ground terminal;
wherein the capacitor and the current source modulate the output voltage by modulating a driving voltage at the control terminal to perform a soft-start operation of the output voltage.

2. The soft-start circuit as claimed in claim 1 further comprising:
a resistor coupled between the output terminal and the ground terminal;
wherein the transistor, the capacitor, the current source, and the resistor are disposed in one chip.

3. The soft-start circuit as claimed in claim 1 further comprising:
a switch coupled between the control terminal of the transistor and the current source;
wherein the switch is turned on, the current source performs a discharging operation such that a voltage level of the driving voltage falls.

4. The soft-start circuit as claimed in claim 3, wherein when a voltage level of the output voltage starts to rise, the capacitor modulates the voltage level of the driving voltage according to the discharging operation and the voltage level of the output voltage.

5. The soft-start circuit as claimed in claim 4, wherein when the capacitor modulates the voltage level of the driving voltage according to the discharging operation and the voltage level of the output voltage, the voltage level of the driving voltage falls slowly and linearly and remains approximately in a fixed voltage level range.

6. The soft-start circuit as claimed in claim 4, wherein when the capacitor modulates the voltage level of the driving voltage according to the discharging operation and the voltage level of the output voltage, the voltage level of the output voltage rises toward a voltage level of the input voltage to achieve the soft-start operation of the output voltage.

7. The soft-start circuit as claimed in claim 4, wherein when the voltage level of the output voltage rises to approach a voltage level of the input voltage, the voltage level of the driving voltage starts to fall toward a voltage level of the ground terminal.

8. The soft-start circuit as claimed in claim 1, wherein when the capacitor modulates a voltage level of the driving voltage according to a discharging operation of the current source and a voltage level of the output voltage, the transistor operates in a saturation region.

9. The soft-start circuit as claimed in claim 1, wherein the current source is implemented by a constant current source.

10. A power supplier for generating a supplying voltage, comprising:
a voltage generation circuit receiving an output voltage and generating the supplying voltage according to the output voltage; and
a soft-start circuit generating the output voltage at an output terminal, wherein the soft-start circuit comprises:
a transistor having a first terminal receiving an input voltage, a second terminal coupled to the output terminal, and a control terminal;
a capacitor coupled between the second terminal and the control terminal of the transistor; and
a current source coupled between the control terminal of the transistor and a ground terminal;
wherein the capacitor and the current source modulate the output voltage by modulating a driving voltage at the control terminal to perform a soft-start operation of the output voltage.

11. The voltage supplier as claimed in claim 10, wherein the soft-start circuit further comprises:
a resistor coupled between the output terminal and the ground terminal;
wherein the transistor, the capacitor, the current source, and the resistor are disposed in one chip.

12. The voltage supplier as claimed in claim 10 further comprising:
a switch coupled between the control terminal of the transistor and the current source;
wherein the switch is turned on, the current source performs a discharging operation such that a voltage level of the driving voltage falls.

13. The voltage supplier as claimed in claim 12, wherein when a voltage level of the output voltage starts to rise, the capacitor modulates the voltage level of the driving voltage according to the discharging operation and the voltage level of the output voltage.

14. The voltage supplier as claimed in claim 13, wherein when the capacitor modulates the voltage level of the driving voltage according to the discharging operation and the voltage level of the output voltage, the voltage level of the driving voltage falls linearly and remains approximately in a fixed voltage level range.

15. The voltage supplier as claimed in claim 13, wherein when the capacitor modulates the voltage level of the driving voltage according to the discharging voltage raises toward a voltage level of the input voltage to achieve the soft-start operation of the output voltage.

16. The voltage supplier as claimed in claim 13, wherein when the voltage level of the output voltage rises to approach a voltage level of the input voltage, the voltage level of the driving voltage starts to fall toward a voltage level of the ground terminal.

17. The voltage supplier as claimed in claim 10, wherein when the capacitor modulates a voltage level of the driving voltage according to a discharging operation of the current source and a voltage level of the output voltage, the transistor operates in a saturation region.

18. The voltage supplier as claimed in claim 10, wherein the voltage generation circuit is a DC-DC converter or a low drop regulator, and an amplifier of the DC-DC converter or the low drop regulator receives the output voltage to serve as a reference voltage.

19. The voltage supplier as claimed in claim 10 further comprising:
a bandgap reference circuit generating a bandgap voltage to the soft-start circuit to serve as the input voltage.

20. The voltage supplier as claimed in claim 10, wherein the current source is implemented by a constant current source.
